(19) United States
(12) Patent Application Publication
(10) Pub. No.: US 2026/0236093 A1
(43) Pub. Date: Aug. 13, 2026

(54) PRESENTATION CONTROL DEVICE, PRESENTATION SYSTEM, AND PRESENTATION CONTROL METHOD

(71) Applicant: Panasonic Intellectual Property Management Co., Ltd., Osaka (JP)

(72) Inventors: Mika SUNAGAWA, Osaka (JP); Aki YONEDA, Hyogo (JP); Shinichi SHIKII, Nara (JP); Koki TAKAHASHI, Osaka (JP); Ryuga YOSHIDA, Tokyo (JP)

(21) Appl. No.: 19/156,839

(22) PCT Filed: Jan. 24, 2024
(86) PCT No.: PCT/JP2024/002103

§ 371 Date: Aug. 14, 2025

(30) Foreign Application Priority Data
Mar. 6, 2023 (JP) 2023-034052

(51) Int. Cl. G06F 3/01; G05D 1/222; G06F 3/14; G09G 3/00

(52) U.S. Cl. CPC G06F 3/013; G05D 1/2235; G06F 3/14; G09G 3/002

(57) ABSTRACT

A presentation control device includes: an acquirer that acquires position information that indicates a corresponding position of a visual target object in a real space, the corresponding position corresponding to a position of the visual target object in content viewed by a wearer, the content being displayed on a display device provided in a wearable member worn by the wearer; and a presenter that causes a presentation device to present presentation information that contains the position information to a non-wearer who is not wearing the wearable member.

### TECHNICAL FIELD

The present disclosure relates to a presentation control device, a presentation system, and a presentation control method.

### BACKGROUND ART

Conventionally, a device such as a head-mounted display (HMD) is known that allows a wearer to view content displayed on a display device provided in a wearable member provided in the device by the wearer wearing the wearable member (see, for example, Patent Literature (PTL) 1 and 2).

### CITATION LIST

### Patent Literature

[PTL 1] WO 2015/125508

[PTL 2] Japanese Unexamined Patent Application Publication No. 2018-205647

### SUMMARY OF INVENTION

### Technical Problem

For example, a device designed to be worn by a wearer such as a HMD covers the eyes of the wearer. Accordingly, a third person cannot recognize the line of sight of the wearer, what the wearer is viewing, and the like. For this reason, the wearer may cause a harmful effect to a non-wearer who is around the wearer without wearing the wearable member such as, for example, causing the non-wearer to feel anxious or dangerous.

The present disclosure provides a presentation control device and the like, with which it is possible to suppress a situation in which a wearer who is wearing a wearable member in which a display device is provided causes a harmful effect to a non-wearer who is not wearing the wearable member.

### Solution to Problem

A presentation control device according to one aspect of the present disclosure includes: an acquirer that acquires position information that indicates a corresponding position of a visual target object in a real space, the corresponding position corresponding to a position of the visual target object in content viewed by a wearer, the content being displayed on a display device provided in a wearable member worn by the wearer; and a presenter that causes a presentation device to present presentation information that contains the position information to a non-wearer who is not wearing the wearable member.

A presentation system according to one aspect of the present disclosure includes: the above-described presentation control device; the above-described wearable member; the above-described display device; and the above-described presentation device.

A presentation control method according to one aspect of the present disclosure includes: acquiring position information that indicates a corresponding position of a visual target object in a real space, the corresponding position corresponding to a position of the visual target object in content viewed by a wearer, the content being displayed on a display device provided in a wearable member worn by the wearer; and causing a presentation device to present presentation information that contains the position information to a non-wearer who is not wearing the wearable member.

### Advantageous Effects of Invention

According to the present disclosure, it is possible to provide a presentation control device and the like, with which it is possible to suppress a situation in which a wearer who is wearing a wearable member in which a display device is provided causes a harmful effect to a non-wearer who is not wearing the wearable member.

### BRIEF DESCRIPTION OF DRAWINGS

FIG. 1 is a block diagram showing a configuration of a presentation system according to an embodiment.

FIG. 2 is a diagram showing a specific example of how the presentation system according to the embodiment is used.

FIG. 3 is a flowchart illustrating a processing procedure performed by a presentation control device according to the embodiment.

FIG. 4 is a diagram showing a specific example of how a presentation system according to Variation 2 is used.

FIG. 5 is a diagram showing a specific example of how a presentation system according to Variation 3 is used.

### DESCRIPTION OF EMBODIMENTS

### Underlying Knowledge Forming Basis of the Present Disclosure

Conventionally, head-mounted display (HMD) glasses, augmented reality (AR) glasses, and the like are used as devices that are worn on the head of wearers and display information for the wearers. Such a device covers the eyes of the wearer, and it is therefore difficult for a third person who sees the wearer to recognize the visibility of the wearer such as the line of sight of the wearer, what the wearer is viewing, and the like. For this reason, communication (for example, non-verbal communication) between the wearer and the third person is unlikely to work well.

For example, if a child who is wearing a pair of AR glasses starts running after a dog (AR dog) displayed on the pair of AR glasses, a nearby person who is not wearing a pair of AR glasses may feel dangerous or anxious as if the child suddenly started running because the nearby person cannot see the AR dog.

Conventionally, as techniques for presenting wearer's visibility to a third person, for example, those disclosed in PTLs 1 and 2 mentioned above are known.

PTL 1 discloses a function of presenting a visual target object to a non-wearer on a HMD to notify the non-wearer of the visual target object. Also, PTL 2 discloses a function of presenting the line-of-sight of a wearer to a non-wearer to notify the non-wearer of the line-of-sight of the wearer.

However, in the case where the wearer is viewing a target (non-real target) that does not exist in the real world such as augmented reality (AR) or virtual reality (VR) digital data (content), the non-wearer cannot recognize the presence of the visual target object viewed by the wearer. For this reason, the non-wearer sees the wearer as if he/she is looking at an empty space, which makes it difficult for the wearer and the non-wearer to communicate with each other.

In view of the problem described above, the inventors of the present application arrived at the invention of the present application.

Hereinafter, an embodiment of the present disclosure will be described with reference to the drawings. The embodiment described below is a specific example of the present disclosure. Accordingly, the numerical values, shapes, materials, structural elements, the arrangement and connection of the structural elements, and the like shown in the following embodiment are merely examples, and therefore are not intended to limit the scope of the present disclosure. Accordingly, among the structural elements described in the following embodiment, structural elements not recited in any one of the independent claims are described as arbitrary structural elements.

The diagrams are schematic representations, and thus are not necessarily true to scale. Also, in the diagrams, structural elements that are substantially the same are given the same reference numerals, and a redundant description may be omitted or simplified.

### Embodiment

### [Configuration]

A configuration of presentation system 10 according to an embodiment will be described first.

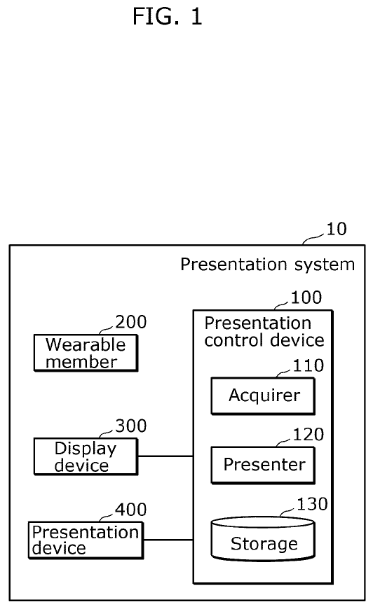

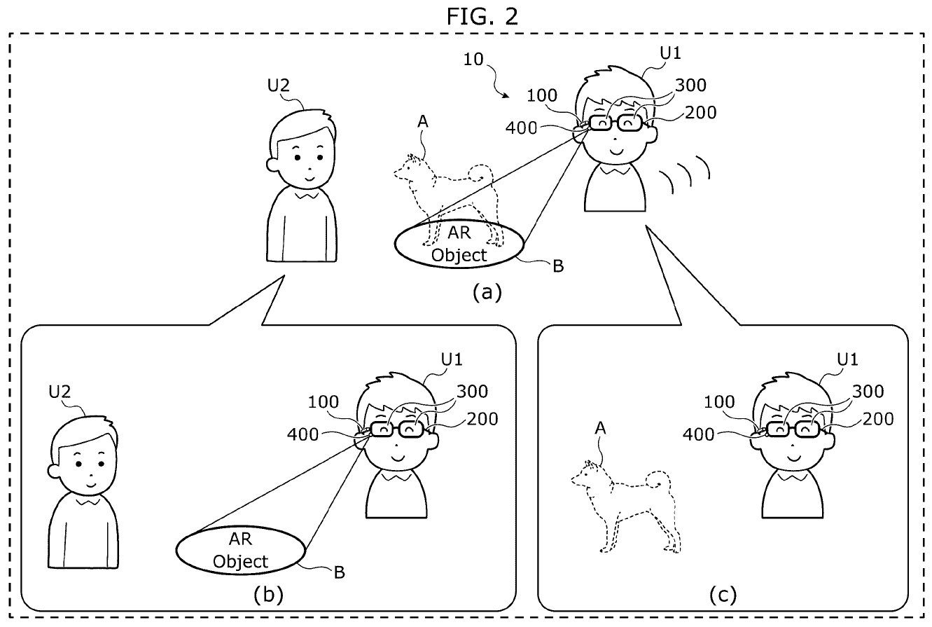

FIG. 1 is a block diagram showing the configuration of presentation system 10 according to the embodiment. FIG. 2 is a diagram showing a specific example of how presentation system 10 according to the embodiment is used. Specifically, (a) in FIG. 2 illustrates user U1 who is playing using presentation system 10 that is displaying a virtual space as content and user U2 who is present around user U1. (b) in FIG. 2 illustrates the view of user U2 in (a) in FIG. 2. (c) in FIG. 2 illustrates the view of user U1. User U1 is an example of a wearer. User U2 is an example of a non-wearer.

Presentation system 10 is a system that displays content displayed on display device 300 provided in wearable member 200 for a wearer who is wearing wearable member 200. Presentation system 10 is, for example, a pair of HMD glasses, AR glasses, or the like.

The term “content” refers to a visual image (display information) such as a still image or a moving image. Specifically, the content may be a visual image of a game or the like in a virtual space such as AR, VR, or mixed reality (MR). The content may contain, not only a visual image of a non-real target, but also a visual image of a real target (for example, a pedestrian walking alongside a wall, an object on the ground, or the like) that cannot be seen directly from user U1 due to shielding or the like. User U1 who is using presentation system 10 is, for example, wearing wearable member 200 on the head and viewing an object in the virtual space. In the present embodiment, display device 300 is a see-through display that allows user U1 to view the real space together with the AR content or the like. User U2 is, for example, a user who is present near user U1 and is not currently viewing the content currently viewed by user U1. User U2 (non-wearer) may be a user who is not wearing a pair of AR glasses or the like, or may be a user who is wearing a pair of AR glasses or the like, but is viewing content different from the content viewed by user U1.

As shown in (a) in FIG. 2, it is assumed that, for example, user U1 who is wearing wearable member 200 is viewing virtual object A such as a dog displayed on display device 300 as AR content or the like. It is also assumed that user U2 who is not wearing wearable member 200, or in other words, user U2 who is not viewing the content is present around user U1. In this situation, when user U1 is playing while running after virtual object A for fun, for user U1, as shown in (c) in FIG. 2, user U1 is simply running after virtual object A, whereas, for user U2, as shown in (b) in FIG. 2, user U2 sees user U1 as if user U1 is recklessly running around because user U2 cannot see virtual object A. For this reason, user U2 cannot predict the movement of user U1, which may create a risk of collision between user U1 and user U2, or the like. To address this, presentation system 10 presents (notifies) information regarding the content viewed by the wearer (user U1) to non-wearer (user U2) who is not wearing wearable member 200 other than the wearer (user U1). Specifically, presentation system 10 presents, to the non-wearer, presentation information that contains position information that indicates a corresponding position of a visual target object in the real space, the corresponding position corresponding to a position of the visual target object in the content viewed by the wearer. In the present embodiment, presentation system 10 presents, to user U2, a corresponding physical position of the visual target object in the real space that corresponds to a position of the visual target object in the content viewed by user U1 by projecting light (a visual image) to the position of the visual target object in the real space. In the example shown in FIG. 2, as the presentation information, image B is projected onto the corresponding position of the visual target object in the real space.

Presentation system 10 includes presentation control device 100, wearable member 200, display device 300, and presentation device 400.

Presentation control device 100 is a control device that controls presentation device 400 to present presentation information that contains position information that indicates a corresponding position of a visual target object in a real space, the corresponding position corresponding to a position of the visual target object in content viewed by a wearer, the content being displayed on display device 300 provided in wearable member 200 worn by user U1.

Presentation control device 100 is, for example, a computer such as a microcomputer. Specifically, presentation control device 100 is implemented by a communication interface for performing communication with display device 300 and presentation device 400, a non-volatile memory in which a program is stored, a volatile memory that is a temporary storage area for executing the program, an input/output port for transmitting and receiving signals, a processor that executes the program, and the like. The communication interface may be implemented by a connector or the like that is connected to a communication line so as to be capable of performing wired communication, or an antenna, a wireless communication circuit, or the like so as to be capable of performing wireless communication.

Presentation control device 100 is provided in, for example, wearable member 200.

Presentation control device 100 may be a computer such as a personal computer or a tablet terminal. Also, presentation control device 100 may or may not be provided in wearable member 200.

Wearable member 200 is a portion that is configured to be worn by user U1 and comes into contact with user U1. Wearable member 200 is worn, for example, on the head of user U1 to cover the field of view of user U1. In the present embodiment, wearable member 200 is an eyeglass frame.

Display device 300 is a display that displays content. Display device 300 is implemented by, for example, a display device such as a liquid crystal panel or an organic electroluminescent (EL) panel. In the present embodiment, the eyeglass lens portion functions as display device 300.

Display device 300 is, for example, a see-through display, but may be a non-transmissive (immersive) display through which the real space cannot be seen from user U1. In the case where display device 300 is a non-transmissive display, for example, the content contains a visual image of a space that corresponds to the real space.

Presentation device 400 is a device that presents presentation information that contains position information. In the present embodiment, presentation device 400 is a light source, and presents the presentation information to user U2 by projecting the content, using light, as image B onto a wall, the ground, or the like around user U1. Presentation device 400 presents the position information to user U2 by, for example, projecting image B onto a corresponding position of virtual object A, which is the visual target object, in the real space. Presentation device 400 is provided in, for example, wearable member 200.

Presentation device 400 does not need to be provided in wearable member 200.

The presentation information may also contain, in addition to the position information, information regarding the visual target object such as “AR Object” shown by image B.

The light source may be any type of light source. For example, the light source may be a light emitting diode (LED) or a laser diode (LD).

The position information is information that indicates the position of the visual target object in the content viewed by user U1. The presentation information is information that contains the position information and is to be presented to user U2. In the present embodiment, the position information (the presentation information that contains the position information) is presented to user U2 by irradiating, with light, the corresponding position of virtual object A in the real space.

The position information may be presented by irradiating, with light, the corresponding position of virtual object A in the real space, or by irradiating, with light, a position slightly apart (for example, a position about 1 meter apart) from the corresponding position of virtual object A in the real space. Alternatively, the position information may be presented by showing a message such as “there is an AR object at a position about ⋅⋅ meters apart to the left from here”. In this case, the presentation information may be presented (for example, image B may be projected) at a position unrelated to the corresponding position of virtual object A in the real space. In this case, for example, the image may be projected at a position near user U2.

Next, a configuration of presentation control device 100 will be described.

Presentation control device 100 includes acquirer 110, presenter 120, and storage 130.

Acquirer 110 is a processing unit that acquires position information that indicates a corresponding position of a visual target object in the real space, the corresponding position corresponding to a position of the visual target object in content viewed by user U1, the content being displayed on display device 300 provided in wearable member 200 worn by user U1. For example, acquirer 110 acquires the position information by calculating the position of the visual target object based on the content and generating the position information that indicates the position of the visual target object calculated. The content is stored in, for example, storage 130. The content may be acquired from an external server by performing communication with the external server. Presentation control device 100 may include a communication interface, such as a wireless communication circuit, for performing communication with an external device such as the external server. Acquirer 110 generates presentation information that contains the position information.

The presentation information is information that is to be presented by presentation device 400. For example, the presentation information is position information that indicates the position of the visual target object in the real space. As will be described later, the presentation information may contain information regarding the visual target object or the content, or the like.

Also, for example, acquirer 110 acquires the position information by determining, based on line-of-sight information that indicates the line of sight of user U1, the visual target object in the content viewed by user U1, and calculating a corresponding position of the determined visual target object in the real space.

The line-of-sight information is, for example, an image of the eyes of user U1 captured by a camera or the like. For example, acquirer 110 acquires the image from the camera, and calculates the line of sight (line-of-sight direction) of user U1 based on the acquired image. Acquirer 110 determines the visual target object viewed by user U1 based on, for example, the line-of-sight information that indicates the line of sight of user U1, information regarding the content displayed on display device 300, and an image of user U1 captured by a camera or the like. In the case where, for example, the determined visual target object is a visual target object in the content, acquirer 110 calculates, based on the content (specifically, visual image information that is information regarding the content displayed on display device 300), the corresponding position of the visual target object in the real space.

The camera may or may not be provided in presentation system 10. For example, the camera may be provided in presentation system 10 at a position where the camera can capture images of the eyes of user U1 in wearable member 200. Also, presentation control device 100 may include a communication interface for performing communication with the camera.

Also, for example, acquirer 110 makes, based on the line-of-sight information, a determination as to the visual target object viewed by user U1 is a visual target object in the content or a visual target object in the real space, and determines a presentation form for presenting the presentation information, based on a result of the determination.

For example, acquirer 110 determines different presentation information depending on whether the visual target object viewed by user U1 is a visual target object in the content or a visual target object in the real space. That is, acquirer 110 determines a different presentation form depending on whether the visual target object viewed by user U1 is a visual target object in the content or a visual target object in the real space. For example, acquirer 110 determines the visual target object in the manner described above, and then determines whether the determined visual target object is a visual target object in the content or a visual target object in the real space. In the case where, for example, the determined visual target object is a visual target object in the content, acquirer 110 calculates a corresponding position of the visual target object in the real space, and presenter 120 causes the presentation device to present image B or the like as presentation information at a position indicated by the position information. On the other hand, in the case where, for example, the determined visual target object is a visual target object in the real space, acquirer 110 does not calculate the position of the visual target object, and presenter 120 does not cause the presentation device to present presentation information.

User U1 is basically viewing the content displayed on display device 300. For example, in the example shown in FIG. 2, user U1 is basically viewing virtual object A. Accordingly, acquirer 110 may determine an object in the content (for example, an object in the content other than the background) as the visual target object viewed by user U1. In this case, acquirer 110 does not need to acquire the line-of-sight information.

Presenter 120 is a processing unit that causes presentation device 400 to present the presentation information that contains the position information to user U2 who is not wearing wearable member 200. Specifically, presenter 120 causes presentation device 400 to present the presentation information in the presentation form determined by acquirer 110. In the present embodiment, presenter 120 controls presentation device 400, which is a light source, based on the presentation information to cause the light source to emit light to present the presentation information.

In the case where the presentation information is presented using light, and display device 300 is a see-through display device 300 (or in other words, a translucent display), for example, a color filter that absorbs and/or reflects the wavelength of light emitted from presentation device 400 may be provided on, for example, a side of display device 300 opposite to the side of display device 300 that faces the eyes of user U1. With this configuration, user U1 can enjoy the content without having to care about the presentation information.

The processing units such as acquirer 110 and presenter 120 are implemented by, for example, one or more processors such as central processing units (CPUs). Acquirer 110 and presenter 120 may be implemented by, for example, a common processor or independent processors.

Storage 130 is a storage device in which programs executed by the processing units such as acquirer 110 and presenter 120 to perform processing, information required to perform the processing, content, and the like are stored. Storage 130 is implemented by, for example, a semiconductor memory or the like.

### [Processing Procedure]

Next, a processing procedure performed by presentation control device 100 according to the embodiment will be described.

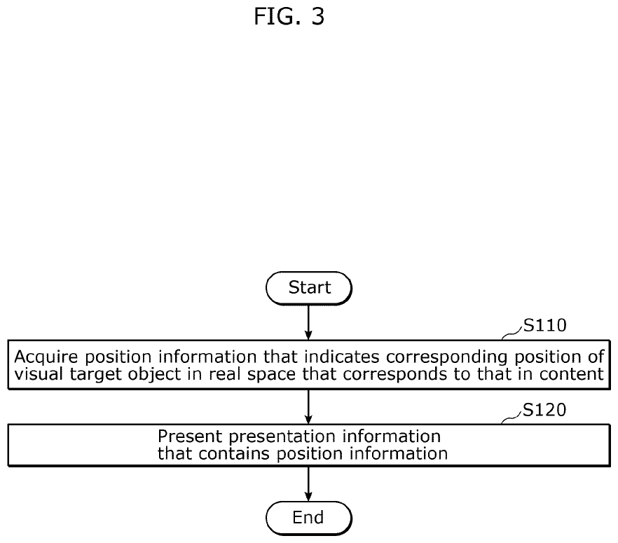

FIG. 3 is a flowchart illustrating the processing procedure performed by presentation control device 100 according to the embodiment.

First, acquirer 110 acquires position information that indicates a corresponding position of a visual target object in the real space, the corresponding position corresponding to a position of the visual target object in content viewed by user U1, the content being displayed on display device 300 provided in wearable member 200 worn by user U1 (S110).

Next, presenter 120 causes presentation device 400 to present presentation information that contains the position information acquired by acquirer 110 to user U2 who is not wearing wearable member 200 (S120). Specifically, presenter 120 causes presentation device 400 to present the presentation information to user U2 by controlling presentation device 400 (S120).

As already described above, a situation may occur in which verbal communication and non-verbal communication between user U1 and user U2 do not work well because the visibility of a wearer who is wearing a HMD or the like cannot be recognized by a third person. To address this, conventionally, for example, a function of presenting the line of sight of the wearer who is wearing the HMD or the like and the visual target object viewed by the wearer to the third person has been proposed. However, the third person cannot recognize the presence of an object in the AR or MR content or the like, and thus, for example, the third person cannot predict the movement of the wearer who is running after an AR object such as virtual object A, which may create a risk of collision between the wearer and the third person. However, with presentation control device 100, the position information is presented to the third person by projecting light (for example, laser light) to the physical position of the visual target object viewed by the wearer. Accordingly, it is possible to cause the third person to easily recognize the position of the visual target object viewed by the wearer.

### [Variations]

Next, variations of the presentation system will be described. The variations given below will be described focusing on differences from the configuration of presentation system 10 described above.

### <Variation 1>

(1) Information regarding a direction of movement, a color, and/or a size of the visual target object, or the like may be presented. That is, the presentation information may further contain target object information that corresponds to at least one of a size, a direction of movement, a color, and a shape of the visual target object in the content viewed by user U1.

For example, “AR Object” shown by image B in FIG. 2 may be an arrow that indicates a direction in which virtual object A moves.

With this configuration, user U2 can more accurately recognize the situation.

(2) As the presentation information, the content (visual image) displayed on display device 300 may be projected. For example, the presentation device may be a projector. In this case, for example, presenter 120 may cause the projector to present the presentation information by controlling, based on the presentation information, the projector to project a visual image of the visual target object in the content viewed by user U1.

For example, “AR Object” shown by image B in FIG. 2 may be an image of virtual object A.

With this configuration, user U2 can more accurately recognize the situation.

(3) The presentation information may further contain meta-information that is related to the content. The meta-information contains, for example, a content title, a content production company name, and the like. For example, the meta-information that contains the content title, the content production company name, and the like may be contained in the presentation information.

For example, “AR Object” shown by image B in FIG. 2 may be character information that indicates the type of content such as “PET GAME”.

With this configuration, content licensing issues can be overcome.

(4) Whether to present the presentation information may be determined based on external environment information regarding an environment of a location, in the real space, where user U1 is present.

The external environment information is, for example, outside information such as a visual image of the surroundings of user U1 captured by a camera. For example, acquirer 110 determines, based on the external environment information, whether to cause presentation device 400 to project image B. There is a situation in which the presentation information should not be projected such as a situation in which, for example, image B is superimposed on an information guide that a third person is looking at, a third person's belongings, or the like, which may cause a nuisance to the third person. To avoid such a situation, for example, acquirer 110 determines, based on the external environment information, whether to present the presentation information. If acquirer 110 determines to present the presentation information, presenter 120 causes presentation device 400 to project image B. If acquirer 110 determines not to present the presentation information, presenter 120 does not cause presentation device 400 to project image B.

In the case where there is no one for which the presentation information needs to be presented, such as user U2, around user U1, it is unnecessary to project the presentation information, and it is therefore unnecessary to project image B.

For example, in the case where the determined visual target object is a visual target object in the real space, acquirer 110 may determine, based on the external environment information, whether user U2 is present around user U1. If acquirer 110 determines that user U2 is present around user U1, acquirer 110 may calculate the position of the visual target object, and presenter 120 may cause presentation device 400 to present presentation information that indicates that user U1 is looking at that position. In this case, if acquirer 110 determines that user U2 is not present around user U1, for example, presenter 120 does not cause the presentation device to present the presentation information. Also, for example, in the case where the determined visual target object is a visual target object in the real space, acquirer 110 may cause presenter 120 to cause the presentation device to present information that indicates that the content is being displayed by user U1.

Also, for example, the presentation form for presenting the presentation information may be changed according to the distance between user U2 and virtual object A. For example, acquirer 110 determines, based on the external environment information, the distance between user U2 and virtual object A. If it is determined that the distance between user U2 and virtual object A is less than a predetermined distance, acquirer 110 determines to present the presentation information in a first form as the presentation form for presenting the presentation information. If it is determined that the distance between user U2 and virtual object A is greater than or equal to the predetermined distance, acquirer 110 determines to present the presentation information in a second form as the presentation form for presenting the presentation information. For example, if it is determined that the distance between user U2 and virtual object A is greater than or equal to the predetermined distance, acquirer 110 determines a presentation form that causes image B to turn into white. On the other hand, for example, if it is determined that the distance between user U2 and virtual object A is less than the predetermined distance, it means that user U2 is too close to virtual object A, which may cause danger to user U2. Accordingly, acquirer 110 determines a presentation form that causes image B to turn into red as a warning. Presenter 120 controls presentation device 400 to present the presentation information in the presentation form determined by acquirer 110.

As described above, acquirer 110 may determine the presentation form for presenting the presentation information based on the external environment information regarding the environment of the location, in the real space, where user U1 is present. In this case, for example, presenter 120 causes presentation device 400 to present the presentation information in the determined presentation form. Also, the external environment information may contain information regarding user U2 who is at the location, in the real space, where user U1 is present such as, for example, the position of user U2.

The external environment information may be, for example, a visual image of the location where user U1 is present, information that indicates the coordinates of the location where user U1 is present obtained from a global positioning system (GPS) or the like, or information that indicates the number of people, traffic volume, traffic sign positions, the type of traffic sign, or the like in the location where user U1 is present. Presentation system 10 may include a GPS receiver.

Also, the information regarding user U2 may be, for example, information that indicates the position of user U2, information that indicates the number of users U2, information that indicates a communication address of a smartphone (for example, presentation device 402, which will be described later) held by user U2, or the like.

(5) The presentation information may contain information that guides user U2 to change the position or movement of user U2. For example, “AR Object” shown by image B in FIG. 2 may be replaced by a message “Move to the left”, an arrow that indicates an escaping/avoiding direction, which is a direction in which user U2 should move, and is not a direction in which virtual object A moves, or the like. Also, for example, “AR Object” shown by image B in FIG. 2 may be replaced by an illusion image or a visual image of an obstacle, such as a rock, which may cause user U2 to naturally change the position or escape/avoid the position.

(6) The substance of the presentation information and/or the presentation form may be changed based on future information regarding the future of the visual target object or the current state of the visual target object.

For example, acquirer 110 may determine the substance of the presentation information and/or the presentation form based on the future information regarding the future of the visual target object or the current state of the visual target object such that the presentation position at which the presentation information is to be presented is shifted to a position at which user U2 can easily visually recognize the presentation information, the position or direction of movement of the visual target object after a predetermined period of time passes from the current time is indicated by the presentation information, or the presentation information is presented, with the visual target object being shown to be larger than the original size of the visual target object (for example, with a light spot such as image B being shown to be larger than the original size of the visual target object).

With this configuration, user U2 can easily take a more reliable escaping/avoiding action in advance such as keeping a sufficient distance.

For example, acquirer 110 detects, based on the external environment information (specifically, a visual image of the surroundings of user U1 captured by a camera), the line-of-sight direction of user U2 in the visual image, and then determines the presentation form (presentation position) such that the presentation information is presented at a position within the field of view of user U2. With this configuration, it is possible to present the presentation information at a position at which user U2 can easily visually recognize the presentation information.

Also, for example, acquirer 110 determines, based on the external environment information (specifically, a visual image of the surroundings of user U1 captured by a camera), the brightness and/or reflectivity of the ground, a wall or the like around user U1, and then determines, based on a result of the determination, the presentation form (presentation position) such that the presentation information (for example, image B) is presented (projected) at a position at which laser light or the like from presentation device 400 used to present the presentation information can be easily seen.

Also, the presentation form for presenting the presentation information may be determined based on the environment where the presentation information is presented. For example, when the environment where the presentation information is presented is outdoor, a visual image of an obstacle such as a rock or a twig may be contained in the presentation information.

With this configuration, it is possible to suppress discomfort felt by user U2 seeing the presentation information.

(7) The presentation information may be presented in an auditory manner. Specifically, the presentation information may be presented to user U2 using a sound. The presentation device may be, for example, a loudspeaker that emits a sound outward from user U1. For example, presenter 120 causes the loudspeaker to output the presentation information using a sound/voice by controlling the loudspeaker.

For example, an output form for outputting the sound/voice that indicates the presentation information may be determined based on a positional relationship between the visual target object and user U2. For example, the output form for outputting the sound/voice that indicates the presentation information may be determined such that the sound volume increases as the distance between the corresponding position of the visual target object in the real space and the position of user U2 is shorter.

Alternatively, the presentation device may be a hearing device such as earphones used by user U2. That is, presentation control device 100 may be configured to operate in conjunction with a device As described above, acquirer 110 may determine the sound output form such as a sound volume, a sound pitch, and/or a sound tone according to, for example, the positions of user U2 and the visual target object, the distance between user U2 and the visual target object, the direction of movements of user U2 and the visual target object, and/or the size of the visual target object.

(8) The presentation information may be presented in a tactile manner. Specifically, the presentation information may be presented to user U2 using a tactile stimulus such as vibration or heat. The presentation device may be, for example, a vibration device that emits a sound wave or the like into the air to apply vibration to user U1. For example, presenter 120 causes the vibration device to present the presentation information by controlling the vibration device. Also, for example, the presentation device may be, for example, a heater that applies heat to user U1. For example, presenter 120 causes the heater to present the presentation information by controlling the heater.

For example, an output form for outputting the vibration or heat may be determined based on the positional relationship between the visual target object and user U2. For example, the temperature of the heater may be determined such that the temperature increases as the distance between the corresponding position of the visual target object in the real space and the position of user U2 is shorter. In this way, the position information (specifically, the distance between the visual target object and user U2) may be notified, using heat, to user U2. Also, for example, the frequency of the vibration from the vibration device (for example, the sound wave emitted from the vibration device) may be determined such that the frequency of vibration increases as the distance between the corresponding position of the visual target object in the real space and the position of user U2 is shorter. In this way, the position information (specifically, the distance between the visual target object and user U2) may be notified, using vibration, to user U2.

Also, the presentation device may be a vibration device or a haptic device used by user U2 such as a smartphone, a smart watch, or smart glasses.

As described above, acquirer 110 may determine a stimulus output form such as an intensity, a position, and/or a direction of the stimulus such as vibration or heat according to, for example, the positions of user U2 and the visual target object, the distance between user U2 and the visual target object, the direction of movements of user U2 and the visual target object, and/or the size of the visual target object.

For example, the tactile stimulus may be applied to an exposed portion of the skin of user U2 so that user U2 can easily perceive the tactile stimulus. Specifically, the tactile stimulus may be applied to the face, the neck, the hand, or the like of user U2.

For example, acquirer 110 may detect, based on the external environment information (specifically, a visual image of the surroundings of the wearer captured by a camera), an exposed position of the skin of user U2 in the visual image, and then determine, based on a result of the detection, the presentation form such that presentation device 400 is controlled.

Also, for example, the stimulus position may be a part of the body of user U2 where user U2 does not feel uncomfortable when stimulated. For example, the stimulus position may be the shoulder or the like because many people feel uncomfortable when their flank or the like is stimulated.

(9) The presentation information may be presented using any one of a liquid, a powder, or a gas. The presentation device may present the position information by, for example, emitting water, an ink, a fine powder, and/or fine particles to the physical position of the visual target object. Also, for example, the presentation device may present the position information by emitting a low-temperature gas to the presentation position to visualize water and/or fine particles contained in the air. Alternatively, for example, the presentation device may present the position information by emitting a gas that contains fine particles to the presentation position to present the position information using scattered light (visualize the position of the visual target object). Alternatively, the presentation device may emit an odorous substance as an emission substance to show the physical position of the visual target object.

The emission amount of the liquid, the powder, and/or the gas and/or the emission substance may be determined according to at least one of a size, a direction of movement, a color, and a shape of the visual target object. Also, the emission amount and/or the emission substance may be controlled based on the external environment information regarding the environment of the location where user U1 is present. For example, in the case where there is a third person or a third someone's belongings at the presentation position, the presentation device does not need to shift the emission position or emit the liquid, the powder, and/or the gas. Alternatively, the emission amount and/or the emission substance may be determined based on the positional relationship between user U2 who is present around user U1 and the position of the visual target object. For example, if it is determined that the distance between user U2 and virtual object A is less than a predetermined distance, the presentation device may emit an uncomfortable odor to prompt user U2 to escape/avoid the position.

As described above, the presentation device may include an emission source that emits any one of a liquid, a powder, or a gas. In this case, for example, presenter 120 causes the emission source to present the presentation information by controlling the emission source based on the presentation information to cause the emission source to emit any one of a liquid, a powder, or a gas.

The type of liquid, the components (materials) of the powder, and the type of gas may be arbitrarily set. Also, the emission source that emits an element such as a liquid, a powder, or a gas includes, for example, a tank that stores the element and a driver for emitting the element from the tank such as a motor or a pump. However, the emission source may have any configuration.

### <Variation 2>

The presentation device may be a mobile unit that is movable such as a radio-controlled mobile unit, a robot, or a drone.

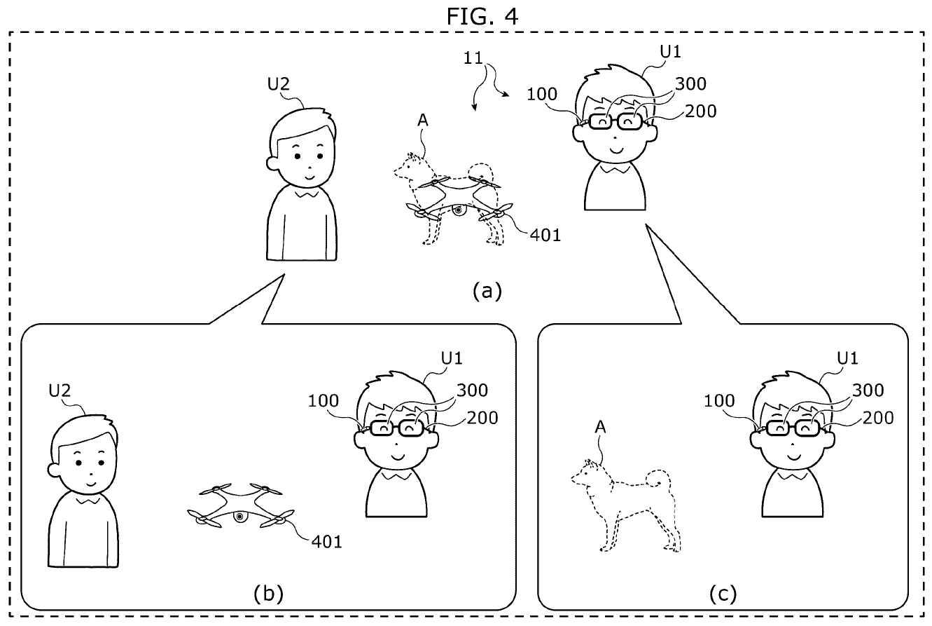

FIG. 4 is a diagram showing a specific example of how presentation system 11 according to Variation 2 is used. Specifically, (a) in FIG. 4 illustrates user U1 who is playing using presentation system 11 that is displaying a virtual space as content and user U2 who is present around user U1. (b) in FIG. 4 illustrates the view of user U2 in (a) in FIG. 4. (c) in FIG. 4 illustrates the view of user U1.

Presentation system 11 is different from presentation system 10 in that presentation system 11 includes a presentation device different from that of presentation system 10.

Presentation device 401 included in presentation system 11 is a mobile unit that can move by being controlled by presenter 120. For example, presenter 120 performs communication with a mobile unit such as a radio-controlled mobile unit or a drone to control the mobile unit to move to the corresponding position of virtual object A in the real space (to superimpose the mobile unit on virtual object A), and thereby presents, to user U2, the position information that indicates the corresponding position of virtual object A in the real space.

With this configuration, the presentation information (position information) can be presented to user U2 in a more stable manner because the presentation information can be projected successfully without being blocked as in the case of laser light.

Also, in the case where a drone is used as the presentation device, it is possible to more accurately present a vertical position (a position in the vertical direction) of virtual object A, and move the drone to a position at which user U2 can easily view the presentation information.

As described above, presentation device 401 may be a mobile unit. In this case, for example, presenter 120 causes the mobile unit to present the presentation information by controlling the mobile unit based on the presentation information.

Presentation control device 100 may include a communication interface for performing communication with the mobile unit such as a wireless communication circuit.

<variation 3>

The presentation device may be a second device such as a smartphone used by user U2, a HMD used by user U2, or a projector that is not provided in wearable member 200.

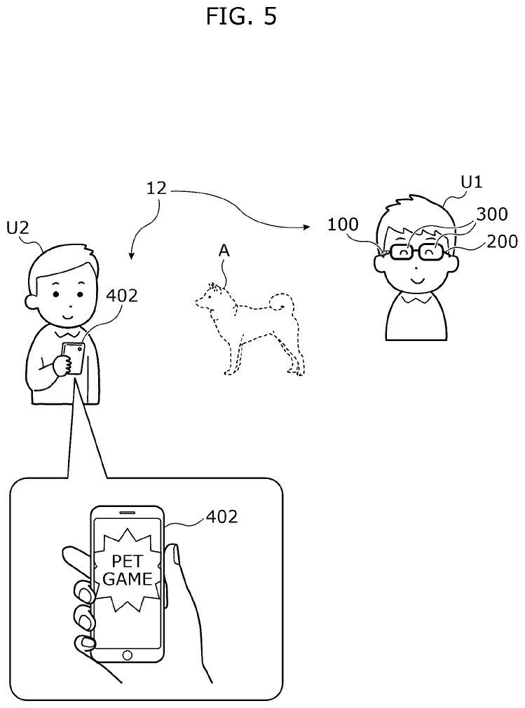

FIG. 5 is a diagram showing a specific example of how presentation system 12 according to Variation 3 is used.

Presentation system 12 is different from presentation system 10 in that presentation system 12 includes a presentation device different from that of presentation system 10.

Presentation device 402 included in presentation system 12 is an electronic device used by user U2. In the present variation, presentation device 402 is a smartphone held by user U2. Presenter 120 presents the presentation information (position information) to user U2 by, for example, performing communication with the electronic device to distribute the position information to the electronic device, and causing a display device such as a display included in the electronic device to display the position information.

With this configuration, user U2 can more accurately recognize the situation.

Here, a situation may occur in which, for example, user U2 cannot acquire the content due to restrictions such as licensing. For example, a licensing issue or the like may arise if the content used by user U1 is transmitted directly to the electronic device held by user U2, without making any change. To address this problem, for example, acquirer 110 generates presentation information that includes a visual image that is different from the content displayed on display device 300 or meta-information that contains the content title and the content production company name.

With this configuration, content licensing issues can be overcome. Also, in the case where the content is a violent game or an action game that involves bloody scenes or the like, it is possible to avoid a situation in which user U2 who does not like such contents accidentally sees the content.

Also, user U2 may select information to be contained in the presentation information.

For example, in the case where a plurality of wearers are in the same location such as the case where a plurality of wearers are nearby each other, user U2 may make a setting to cause presentation device 402 to present only the presentation information that contains visually recognized information (the position information that indicates the position of the visual target object) of a specific wearer or a specific content user. For example, user U2 may operate an operation receiver that receives an operation input from user U2 such as a touch panel display included in presentation device 402 to input settings information for determining information to be presented by presentation device 402. Presentation device 402 may determine, based on the settings information, the information to be presented by presentation device 402 from among one or more information items contained in the presentation information acquired from presentation control device 100. Also, for example, presentation device 402 may transmit the settings information to presentation control device 100. In this case, for example, presentation control device 100 may determine, based on the settings information, information to be contained in the presentation information.

As described above, as a result of user U2 being able to select the information to be presented by presentation device 402, it is possible to avoid a situation in which user U2 is overwhelmed by a large amount of information.

Also, for example, presentation device 402 may preferentially weight a visual target object visually recognized by a plurality of wearers who are in the same location such as, for example, nearby each other before presenting the presentation information. For example, in the case where a plurality of presentation information items are acquired from a plurality of presentation control devices 100, presentation device 402 may perform the above-described weighting based on the plurality of acquired presentation information items.

With this configuration, user U2 can more easily recognize the surrounding situation.

As described above, presentation device 402 may be an electronic device used by user U2. In this case, for example, presenter 120 causes the electronic device to present the presentation information by transmitting the presentation information Presentation control device 100 may include a communication interface for performing communication with the electronic device or the like such as a wireless communication circuit.

### [Advantageous Effects, etc.]

Hereinafter, a technique obtained from the disclosure in the specification of the present application will be illustrated, and advantageous effects and the like obtained from the technique will be described.

Technique 1 provides presentation control device 100 including: acquirer 110 that acquires position information that indicates a corresponding position of a visual target object in a real space, the corresponding position corresponding to a position of the visual target object in content viewed by a wearer, the content being displayed on display device 300 provided in wearable member 200 worn by the wearer; and presenter 120 that causes a presentation device to present presentation information that contains the position information to a non-wearer who is not wearing wearable member 200.

The wearer is, for example, user U1 described above. The presentation device is, for example, at least one of presentation device 400, 401, or 402 described above.

With this configuration, the physical position of the visual target object viewed by the wearer can be notified to the non-wearer using the presentation information. When the non-wearer can recognize the presence of the visual target object, the non-wearer can predict, for example, the movement of the wearer who is running after the visual target object, and thus the non-wearer can avoid the wearer or reduce the anxiety about the behavior of the wearer. For this reason, with presentation control device 100, it is possible to suppress a situation in which the wearer who is wearing wearable member 200 in which display device 300 is provided causes a harmful effect to the non-wearer who is not wearing wearable member 200.

Technique 2 provides presentation control device 100 according to technique 1, wherein acquirer 110 acquires the position information by determining, based on line-of-sight information that indicates a line of sight of the wearer, the visual target object in the content viewed by the wearer, and calculating the corresponding position of the visual target object determined in the real space.

With this configuration, in the case where the content contains a plurality of target objects, the visual target object viewed by the wearer, or in other words, the position of one of the plurality of target objects in the real space that is highly likely to affect the behavior of the wearer can be presented to the non-wearer.

Technique 3 provides presentation control device 100 according to technique 2, wherein acquirer 110 makes, based on the line-of-sight information, a determination as to whether the visual target object viewed by the wearer is the visual target object in the content or the visual target object in the real space, and determines a presentation form for presenting the presentation information, based on a result of the determination, and presenter 120 causes the presentation device to present the presentation information in the presentation form determined.

In the case where, for example, the determined visual target object is the visual target object in the content, acquirer 110 calculates the corresponding position of the visual target object in the real space to thereby acquire position information that indicates the calculated position, and causes presenter 120 to cause the presentation device to present the presentation information such as image B at a position indicated by the position information. On the other hand, for example, in the case where the determined visual target object is the visual target object in the real space, acquirer 110 neither acquires the position information nor causes presenter 120 to cause the presentation device to present the presentation information. For example, when the wearer is viewing the visual target object in the real space, the non-wearer can also view the visual target object. Accordingly, it is unnecessary to present the position of the visual target object to the non-wearer. For this reason, it is unnecessary to present the presentation information, and thus a situation in which the presentation information is presented can be suppressed.

Technique 4 provides presentation control device 100 according to any one of techniques 1 to 3, wherein the presentation information further contains target object information that corresponds to at least one of a size, a direction of movement, a color, or a shape of the visual target object in the content viewed by the wearer.

With this configuration, the non-wearer can more accurately recognize the visual target object.

Technique 5 provides presentation control device 100 according to any one of techniques 1 to 4, wherein the presentation information further contains meta-information that is related to the content.

Although depending on the content, a licensing issue or the like may arise in the case where, for example, the content is projected directly without making any change. With this configuration, the presentation information can be presented to the non-wearer without worrying about such an issue. Also, for example, it is possible to avoid a situation in which the non-wearer accidentally sees uncomfortable content for many people to see such as a violent scene.

Technique 6 provides presentation control device 100 according to any one of techniques 1 to 5, wherein the presentation device an electronic device used by the non-wearer, and presenter 120 causes the electronic device to present the presentation information by transmitting the presentation information to the electronic device.

The electronic device is, for example, presentation device 402.

With this configuration, the non-wearer can more accurately recognize the visual target object.

Technique 7 provides presentation control device 100 according to any one of techniques 1 to 6, wherein the presentation device includes an emission source that emits any one of light, a liquid, a powder, or a gas, and presenter 120 causes the emission source to present the presentation information by controlling, based on the presentation information, the emission source to emit any one of the light, the liquid, the powder, or the gas.

The emission source is, for example, a light source that emits light. The light source is included in, for example, presentation device 400.

Technique 8 provides presentation control device 100 according to any one of techniques 1 to 7, wherein the presentation device includes a projector, and presenter 120 causes the projector to present the presentation information by controlling, based on the presentation information, the projector to project a visual image of the visual target object in the content viewed by the wearer.

That is, in the case where the presentation device is a device that emits light, the presentation device may simply emit light as with a light source, or project images as with a projector. The projector is, for example, presentation device 400.

With the configuration described above, the non-wearer can more accurately recognize the visual target object.

Technique 9 provides presentation control device 100 according to any one of techniques 1 to 8, wherein the presentation device includes a mobile unit, and presenter 120 causes the mobile unit to present the presentation information by controlling, based on the presentation information, the mobile unit to move.

The mobile unit is, for example, presentation device 401.

With this configuration, as compared with, for example, the case of using light to present the presentation information, it is possible to reliably present the position of the visual target object to the non-wearer.

Technique 10 provides presentation control device 100 according to any one of techniques 1 to 9, wherein acquirer 110 determines a presentation form for presenting the presentation information based on external environment information regarding an environment of a location, in the real space, where the wearer is present, and presenter 120 causes the presentation device to present the presentation information in the presentation form determined.

With this configuration, for example, it is possible to suppress a situation in which an image is presented as the presentation information on a traffic sign or the like that the presentation information should not be presented.

Technique 11 provides presentation control device 100 according to technique 10, wherein the external environment information contains information regarding the non-wearer who is at the location, in the real space, where the wearer is present.

With this configuration, the presentation information can be presented appropriately to the non-wearer who may receive a harmful effect from the wearer.

Technique 12 provides a presentation system including: presentation control device 100 according to any one of techniques 1 to 11; wearable member 200; display device 300; and the presentation device.

The presentation system is, for example, presentation system 10, 11, or 12 described above.

With this configuration, the same advantageous effects as those of presentation control device 100 according to one aspect of the present disclosure can be obtained.

Technique 13 provides a presentation control method including: acquiring position information that indicates a corresponding position of a visual target object in a real space, the corresponding position corresponding to a position of the visual target object in content viewed by a wearer, the content being displayed on display device 300 provided in wearable member 200 worn by the wearer (S110); and causing a presentation device to present presentation information that contains the position information to a non-wearer who is not wearing wearable member 200 (S120).

With this configuration, the same advantageous effects as those of presentation control device 100 according to one aspect of the present disclosure can be obtained.

The generic or specific aspects of the present disclosure described above may be implemented by a system, a method, an integrated circuit, a computer program, or a computer-readable non-transitory recording medium such as a CD-ROM, or may be implemented by any combination thereof.

### Other Embodiments, etc.

The embodiment has been described above. However, the present disclosure is not limited to the embodiment given above. Accordingly, the structural elements illustrated in the accompanying drawings and described in the detailed description in the specification of the present application may include not only structural elements required to solve the problem of the present disclosure, but also structural elements that are merely given to illustrate the above-described technique and thus are not required to solve the problem of the present disclosure. For this reason, the structural elements that are not required to solve the problem of the present disclosure should not be construed as requirements of the present disclosure just because of the fact that they are illustrated in the accompanying drawings and described in the detailed description in the specification of the present application.

For example, presentation control device 100 is provided in wearable member 200. However, presentation control device 100 may be implemented by a computer or the like that is not provided in wearable member 200 such as a server.

Also, for example, a processing unit that causes display device 300 to display the content such as a display unit may be included in presentation control device 100.

Also, for example, the presentation system may include any combination of one or more presentation devices 400, one or more presentation devices 401, and one or more presentation devices 402. In this way, the structural elements and the processing operations of the embodiment and the variations given above may be combined in any way to implement the presentation system.

For example, in the embodiment given above, presentation control device 100 is implemented by a single device, but may be implemented by a plurality of devices. In the case where the presentation control device is implemented by a plurality of devices, the structural elements included in the presentation control device described in the embodiment given above may be assigned to the plurality of devices in any way.

Also, in the embodiment given above, processing performed by a specific processing unit may be performed by a different processing unit. Also, the order of a plurality of processing operations may be changed. The plurality of processing operations may be performed in parallel.

Also, in the embodiment given above, the structural elements (the processing units) may be implemented by executing a software program suitable for the structural elements. The structural elements may be implemented by a program executor such as a CPU or a processor reading and executing a software program recorded in a recording medium such as a hard disk or a semiconductor memory.

Also, the structural elements may be implemented using hardware. The structural elements may be circuits (or an integrated circuit). The circuits may constitute a single circuit as a whole, or may be separate circuits. Also, the circuits may be general-purpose circuits or dedicated circuits.

Also, the generic or specific aspects of the present disclosure may be implemented by a system, a device, a method, an integrated circuit, a computer program, or a computer-readable non-transitory recording medium such as a CD-ROM, or may be implemented by any combination thereof.

For example, the present disclosure may be implemented as a presentation control method executed by a computer as the presentation control device or the like. Also, the present disclosure may be implemented as a program for causing a computer to execute the presentation control method, or may be implemented as a computer-readable non-transitory recording medium in which the program is recorded.

The present disclosure also encompasses other embodiments obtained by making various modifications that can be conceived by a person having ordinary skill in the art to the above-described embodiment as well as embodiments implemented by any combination of the structural elements and the functions of the above-described embodiment without departing from the scope of the present disclosure.

### INDUSTRIAL APPLICABILITY

The present disclosure is useful in a device that is worn by a user and displays visual images such as a HMD.

### REFERENCE SIGNS LIST

10, 11, 12 presentation system
100 presentation control device
110 acquirer
120 presenter
130 storage
200 wearable member
300 display device
400, 401, 402 presentation device
U1, U2 user
A virtual object
B image

1. A presentation control device comprising:
an acquirer that acquires position information that indicates a corresponding position of a visual target object in a real space, the corresponding position corresponding to a position of the visual target object in content viewed by a wearer, the content being displayed on a display device provided in a wearable member worn by the wearer; and
a presenter that causes a presentation device to present presentation information that contains the position information to a non-wearer who is not wearing the wearable member.

2. The presentation control device according to claim 1,
wherein the acquirer acquires the position information by determining, based on line-of-sight information that indicates a line of sight of the wearer, the visual target object in the content viewed by the wearer, and calculating the corresponding position of the visual target object determined in the real space.

3. The presentation control device according to claim 2,
wherein the acquirer makes, based on the line-of-sight information, a determination as to whether the visual target object viewed by the wearer is the visual target object in the content or the visual target object in the real space, and determines a presentation form for presenting the presentation information, based on a result of the determination, and
the presenter causes the presentation device to present the presentation information in the presentation form determined.

4. The presentation control device according to claim 1,
wherein the presentation information further contains target object information that corresponds to at least one of a size, a direction of movement, a color, or a shape of the visual target object in the content viewed by the wearer.

5. The presentation control device according to claim 1,
wherein the presentation information further contains meta-information that is related to the content.

6. The presentation control device according to claim 1,
wherein the presentation device includes an electronic device used by the non-wearer, and
the presenter causes the electronic device to present the presentation information by transmitting the presentation information to the electronic device.

7. The presentation control device according to claim 1,
wherein the presentation device includes an emission source that emits any one of light, a liquid, a powder, or a gas, and
the presenter causes the emission source to present the presentation information by controlling, based on the presentation information, the emission source to emit any one of the light, the liquid, the powder, or the gas.

8. The presentation control device according to claim 1,
wherein the presentation device includes a projector, and
the presenter causes the projector to present the presentation information by controlling, based on the presentation information, the projector to project a visual image of the visual target object in the content viewed by the wearer.

9. The presentation control device according to claim 1,
wherein the presentation device includes a mobile unit, and
the presenter causes the mobile unit to present the presentation information by controlling, based on the presentation information, the mobile unit to move.

10. The presentation control device according to claim 1,
wherein the acquirer determines a presentation form for presenting the presentation information based on external environment information regarding an environment of a location, in the real space, where the wearer is present, and
the presenter causes the presentation device to present the presentation information in the presentation form determined.

11. The presentation control device according to claim 10,
wherein the external environment information contains information regarding the non-wearer who is at the location, in the real space, where the wearer is present.

12. A presentation system comprising:
the presentation control device according to claim 1;
the wearable member;
the display device; and
the presentation device.

13. A presentation control method comprising:
acquiring position information that indicates a corresponding position of a visual target object in a real space, the corresponding position corresponding to a position of the visual target object in content viewed by a wearer, the content being displayed on a display device provided in a wearable member worn by the wearer; and
causing a presentation device to present presentation information that contains the position information to a non-wearer who is not wearing the wearable member.
